(19) United States
(12) Patent Application Publication
(10) Pub. No.: US 2008/0157535 A1
(43) Pub. Date: Jul. 3, 2008

(54) Molecular energy extraction chambers

(76) Inventor: Sridat Chinsammy, Schenectady, NY (US)

Correspondence Address: SRIDAT CHINSAMMY, 429 BRANDY WINE AVE, SCHENECTADY, NY, 12308, US

(21) Appl. No.: 11/818,453

(22) Filed: Jun. 14, 2007

Related U.S. Application Data
(60) Provisional application No. 60/855,975, filed on Nov. 1, 2006.

(51) Int. Cl. F02B 63/04

(52) U.S. Cl. 290/1 R

(57) ABSTRACT

My revolutionary idea and invention of the “Molecular Energy Extraction Chambers” is the unique concatenation of principles and concepts of physics, engineering and chemistry with the intent to extract Internal Energy (Latent Energy) from liquids without combustion and with intentional combustion. That is basically the extraction of large volumes of energy from matter (liquid/s) and in so doing consuming negligible mass in the processes. It is totally environmentally friendly, in that it is emission free of any gas and including water in any form and is the alternative energy source with the solution for the world's growing energy dependency on the combustion of fossil fuels.

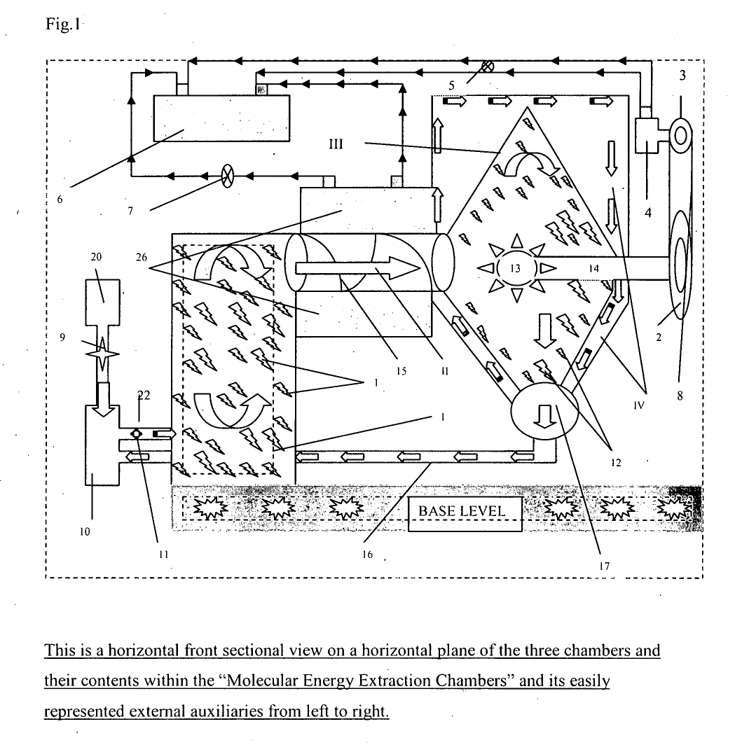

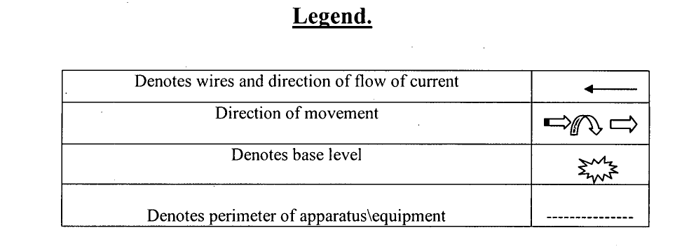

### BRIEF SUMMARY OF INVENTION

My idea and invention of the “Molecular Energy Extraction Chambers” is the unique concatenation of principles and concepts of physics, engineering and chemistry with the intent to extract Internal Energy (Latent Energy) from liquids without and with intentional combustion. That is basically the extraction of large volumes of energy from matter (liquid) and in so doing consuming negligible mass in the processes. I am now establishing a relationship of similarity, as to prove that in certain perspective it is a known field of science and that energy and mass within matter do have a very unique relationship. The preceding statements can be authenticated by using the information obtained by quantitative analysis, during Nuclear Reactions.

It have being found that the sum of the masses of atoms produced as a result of Fission was slightly less than the mass of the original uranium nuclei. This difference represents the energy liberated as heat radiation and kinetic energy of fission products. My idea totally coincides with the kinetic theory of matter, the laws of Thermo Dynamics and all the Gas Laws. This revolutionary process was attainable readily and effectively, because of the basic property of the selective liquid/s that I have used, in that they posses a very low Specific Latent Heat Capacity of Vaporization (volatile) and they posses a reasonably complex molecular structure.

My revolutionary idea and invention is totally environmentally friendly, in that it is emission free of any gas and including water in any form and is the alternative energy source with the solution for the world's growing energy dependency on the combustion of fossil fuels. When implemented it will progressively, result in a cessation of the Global Warming effect (Including the belief accelerated melting of the permafrost) and the believed slow carbonic acidification of the oceans, that which is in the course of driving mankind and other creation to extinction.

This technology when integrated with existing Aerodynamics/Hydrodynamics technologies, Regenerative breaking, “Generative Braking” and Advance batteries technologies. These together with energy trapping systems, e.g. Photovoltaic cells, Wind generation and Rotational Kinetic Energy systems (“Energy of Inertia”). Will significantly impact in a positive sense the economical status of the institution/s involved with, all due to the creation of very efficient and cheap alternative source energy vehicles in the fields of Marine, Land and Air transportation inclusive of Space travels (“Electron Propulsion Systems”). This unique usefulness also applies to the systems supplying electrical energy into the National Grid Networks.

The extent of this integration process of technologies will be dictated by the desired need of the specific vehicle/s or system/s, as to how much of each individual technology will, be utilized and which will not be appropriate for that specific application. The exclusive goal of this technology is to attain an end result in which there is a very large dispensation of output energy, as in contrast to the direct energy supply (Exempting the chemical “Feed”) that the system is receiving during its operation, without coinbusting its source of chemical energy and at any point produces any harmful substance/s that can affect the environment/inhabitance in any way. The amount of energy that the liquid/s (“Feed”) in use embodies for any time period is directly dependant on their molecular structure which entails the strength of the cohesive/adhesive forces within. The “Feed” in general speaking can varies from being water to a colossal list of liquid/s. The operating systems within this technology are modifiable to fit different circumstances but the concepts and principles within will always remain the same.

### A BRIEF DESCRIPTION OF THE VIEW OF THE DRAWINGS

The drawing represents a horizontal front sectional view on a horizontal plane of the three chambers and their contents within the “Molecular Energy Extraction Chambers” and it's easily represented external auxiliaries from left to right. Within the embodiment of the drawings are usage of bold form Roman Numerals and Hindu Arabic Decimal numerals as symbols, that are used to represent the various constituents of the preceding mentioned apparatus.

Additionally, the necessary detailed explanation of the symbols in usage is being furbished in the Detailed Description of my Specification. Accompanying these substances within the pages of the drawings is a Legend that is use to represent other necessary matter of conformity, that which will enhance clarity of understanding.

### DETAILED DESCRIPTION OF INVENTION

I am now proceeding to present a detailed summary of the specifics in the diverse sectors of physics, engineering and to a lesser extent chemistry that were utilize during modeling, together with there operative ness that embodies my revolutionary idea and invention of the “Molecular Energy Extraction Chambers”. With the intention of making this technology, easily understandable to any person/s skilled in the applicable fields of Science or which it is most nearly connected to it. I am having the exclusive goal of making this modifiable technology readily available to the public. My intention is its future integration into all applicable systems and vehicles. The “Molecular Energy Extraction Chambers” operates on the premise that liquid/s e.g. volatile liquid/s (Ethanol and subsequently E85) were atomize by a dual capability injection pump. The fluid injection pump is here in call 11 (see sketch drawing). The atomize liquid is here in referred to as the “feed”. The “feed” was sprayed into a pre-vacuumed chamber here in called chamber I, at various strategic points. (See sketch drawing) Chamber I constitutes mainly of a numerous amount of electrical heating elements I (see sketch drawing) strategically lay out in its internal area, this had facilitate the maximum surface area per volume ratio interaction between the sprayed in “feed” and there heated surfaces and at the same time facilitates the readily and continuous exit movement of the gases that which will soon be within. The temperatures of these heating elements were made to be varied by a central controlled thermostat (Not represented by sketch drawing) the temperatures of the electrical elements were made to be above the natural boiling point of the “feed”. In the circumstance when the “feed” was a mixture of volatile liquids, the temperature was made to be that of the arithmetic mean average derived as a result of using the individual natural boiling points of the liquids. Thus as a result of this unique interaction between the “feed” and the heating elements, there was a rapid change in the state of matter occurring form liquid to the gaseous state.

This occurrence had taken place spontaneously due to the fact that there was a zero atmospheric pressure within chamber I, all due to the pre-vacuuming process. This together with the “Feed” very low Specific Latent Heath Capacity of Vaporization (volatility) had acted as the prelude for all other subsequent processes that which will follow. There was the formation of a new atmosphere of gases within chambers I and there was simultaneously an amplified presence of kinetic energy within the entire available area in chambers I that which had tremendously increases the chamber's internal pressure. (It was intended to mimic the effect of the occurrence of saturation vapor pressure to the limits that the design had permitted and to follow along the same guiding principles that govern it.) It is important to note that saturation vapor pressure at any given temperature is independent of volume of the vapor, so long as there is free liquid present to ensure saturation condition. The preceding occurrences totally coincides with the kinetic theory of matter in relation to liquids and gases (Molecules of liquids and gases are always in constant motion) and the Kinetic value of liquids (Matter in the liquid state constitutes of large amount of internal energy within and if its kinetic energy is made to rise considerably it will vaporize, impacting its surrounding, resulting in the potential for work to be done). The pre-vacuuming process had also acts as the inhibiter to combustion, by depriving the system of the essential element oxygen and had continued to do so in the entirety of the processes to follow. The tremendous pressure built up in chamber I was controllable at this stage of the technology by the varying factors, which were the altering of the temperature of the heating elements and the volume of atomize “feed” entering chamber I at any time period. These variables had continued to play significant rolls in the further extent of this technology as it had progresses to attain optimum efficiency and its exclusive goal. The pressure law was applied. (The pressure of affixed mass of gas at constant volume is proportional to its absolute temperature.) The pressurize gases from chamber's I was made to enter directly into a second conjoining cylindrical shaped pre-vacuumed chamber that which was a quarter the volume of chamber I here in referred to as chamber II (see sketch drawing). Chamber's II serves the purpose of converting the pressurized air columns (Thrust) it was directly receiving from chamber I into torque for the generation of 12 volts DC electricity and yet restrain the process of liquefaction from occurring. This was attainable because chamber's II is design to be that of a howled design of a conventional dynamo Rotor that which was converting thrust into torque within the confines of a reduced volume environment. Boyle's Law (The volume of a fixed mass of gas is inversely proportional to the pressure, provided the temperature remains constant.) This feature was attainable because chamber II inner walls were laid out with helical blades. (Archimedes screw) and a later design was made to mimic the turbine features of a Jet Turbine Engine 15 (see sketch drawing). As the hot gases enters and exit chamber's II it had resulted in its rotation. The walls of this chamber were super thermo insulated using the conventional method of lagging. The varying factor at this phase of the technology was chamber's II internal volume, its length, the number of turns on the helical arrangement and there height/the turbine design itself. This chamber was made to rotate within the circumference of a pair of conventional bearings and later magnetic bearings made out of very powerful permanent magnets. The technology had capitalized on the first Law of Thermodynamics. (Changes in the internal energy of any system are equal to heat inflows plus work done on the system.) Very keen attention was also being paid on minimization of energy lost due to frictional forces, within the design and operation of this chamber; this was clearly reflected in the type of electrical generating system chosen and there rotational attachments.

The electrical energy generated by the dynamo 26 (see sketch drawing) that which was built around chamber's II external circumference, was directed into a 90% pre charged “Battery Bank” comprising mainly of lithium-ion batteries herein referred to as 6 (see sketch drawing) via a wired connection comprising of a flip switch 7 see sketch drawing. (Which was only activated when chamber's II had being made to rotate at optimum desired speed so that sufficient momentum was initially allowed to be gathered under less work load). When the generation of electricity had commenced, this connection was very useful in the enhancement of the operational efficiencies of the dynamo, because it greatly reduces the amount of torque that was needed to make the dynamo perform at peak for any given time period, it was all because the “battery bank” had acted as a large energy deposit readily supplying its consuming system/s adequate amount of electrons, with out letting the dynamo being made to feel the direct garbing effect for electrons, resulting in the dynamo been able to efficiently replenish the electrons that had been utilized by the source/s and was able to accomplish this feat at a lower torque value (operating within its soft zone) the “Battery Bank” had being the buffer. The hot gases that had exited chamber's II was made to enter directly into a conjoining pre-vacuumed and uniquely design refrigeration chamber at temperatures that had varied to the cooling capacity of the refrigerant (Freon) that what was in use at the time and in conjunction with the apparatus design limits. This chamber is here in referred to as chamber III (see sketch drawing) The volume of chamber III was twice that of the sum of the volume of chambers I and II, as to facilitate the continuous flowing of gases from chambers I and II and yet allows for the rapid cooling, condensation and effective collection of gases it was receiving, by adequately facilitating the design implantations that was necessary. The cooling veins 12 in chamber III were arranged in a manner that have facilitated the rapid temperature reduction of the hot gases it was receiving and yet allows for a secondary extraction of energy from the hot gases during the cooling process (see sketch drawing). This was accomplished by the placement of a turbine blade 13 (see sketch drawing) directly in the entrance way of the hot gases in a reasonable distance. This further extraction of energy did not impact the initial processes in any negative way because there was no direct connection between the dynamo of chamber's II and the turbine blades, if so it would have resulted in the occurrence of a drag force on chamber's II, thus negatively affecting its operational efficiency.

The turbine blades were constructed of a material that which was applicable to the current situation. The mechanical energy that the turbines blades have gathered were directly channeled to the outside of the chamber via a steel shaft 14 (see sketch drawing) through an air tight hole, were it was connected to a heavy Thermo insulted plastic pulley 2 (see sketch drawing). This unique feature allows for the further enrichment of energy (“Energy of Inertia”) in the form of Rotational Kinetic Energy, due to a “Quantum Mechanical Phenomena” which was used to produce additional electrical energy from a second dynamo 4 (see sketch drawing) via a cylindrical belt 8 (see sketch drawing) connection using a velocity ratio that had best suited the situation. There was also a similar pulley 3 (see sketch drawing) on the dynamo as the preceding mentioned with the identical mechanical intentions. The derived energy was also channeled to 6 (see sketch drawing), which was serving the very same electro mechanical purpose, as preceding mentioned for a similar connection. A flip switch 5 (see sketch drawing) was placed between this connection acting as a assurance that the pulleys were firstly allowed to reach optimum rotational speed before it was turned on to facilitate the flow of electricity to 6

(See sketch drawing) this unique action had guaranteed that there was a full optainance of “Energy of Inertia” in form of Rotational kinetic Energy. There was also the placement of other secondary safety devices as the situation had warranted. The technology had now entered into a very important energy transfer and Conservation phase.

The paramount feature in the accomplishment of such a feat was the mimicking of conventional refrigeration to a considerable extent. The regular copper condensing coils and cooling fins, was instead being placed around the external perimeter on the top and front sides of chamber's III (This is not represented by sketch drawing) external wall but in this unique case they were fused to a copper mesh of an appropriate geometric pattern, establishing a relation ship of one with most contacts, the mesh was then attached to a copper strip of appropriate thickness, which was extending away, subsequently the copper strip was enclosed in super thermo insulating material where it was necessary, so that the design objective can be attained. This entire arrangement was then encapsulated by an air thigh super thermo insulating plastic covering, exempting the outward extension of insulated copper strip; the space enclosed was then vacuumed (This is not represented by sketch drawing). Vacuuming was used to greatly enhance transfer of heat due to conduction and simultaneously reduces energy lost due to radiation. This unique innovation was used to facilitate the efficient transfer of Latent Energy away from the hot Freon vapor that was present within the circulatory system of the freezing unit, from that ideal vantage point, which eliminates the use of any compressor within the design of the freezing unit. Thus this design alteration along with the laying of the circulatory system within a gravitational flow plane had greatly reduced the energy consumption that which was needed to make this system function effectively and resulted in the enhancement of the exclusive goal within the construction of this apparatus. The preceding mentioned copper strip was made to extend into receptacle 10 (see sketch drawing) at the lowest point of at its base purposely conducting maximum heat into it. (Energy Conservation) This is not represented on sketch drawing. The mechanics within the designs of the” Molecular Energy Extraction Chambers” had dictates the extent of this refrigeration process as the operating systems within it had gathers momentum and starts to operate in a systematic manner. Only a small electrical vacuum pump was incorporated in the designing of this refrigerating system and was synchronies with the other pumps within the design of the apparatus to perform in a manner that which was of an advantage to the over all functioning of the wholesome apparatus. (This is not represented by sketch drawing) The unique geometry that was oriented within the configuration of chamber's III internal walling (mimicking the fusion of two polyhedrons at their base to form one uniformed open space entity) had readily promoted the collection of cooler “Feed” at a single point on its base 17 (see sketch drawing) as it conjoins it self with the forces of gravity, the generated internal turbulence between gas and liquid particles, the created internal temperature differentials and its larger volume. For the intentional increase in volume, Boyle's Law was again applied and for the resulting rapid decrease in pressure, which was used as a convenient constant. Charles's Law (The volume of a fixed mass of gas at constant pressure is proportional to its absolute temperature) was applied as a guiding tool to established that at the prevailing lower temperature, that the volume of gases within chamber's III had decrease for any operational time period because there kinetic energy was caused to deplete, then using this derived volume as a convenient constant the pressure law was again being applied, to establish that the molecule were intentionally made more vulnerable to cooling/trapping (chamber's III had eventually acted as an perpetuating pumping apparatus) thus greatly reduced the overall energy input needed for the extraction of the cooler “Feed” and its vapors (The cooler “Feed” was recycled to receptacle 10 see sketch drawing) in turn greatly enhancing the “Feed” recycling and energy conservation initiative. The three individual chambers within the “Molecular Energy Extraction Chambers” were also arranged in contrast to each other, so as to utilize the forces of gravity at maximum (see sketch drawing) so as to positively impact the “Feed” recycling and energy conservation initiatives. There was also another mechanism which was incorporated into the designing of chambers III which was the double walling to limitedly mimic the contemporary thermo insulating process of lagging (Space is here in referred to as compartment IV). But in this case the spaces between the walls were vacuumed and were filled of Freon to a necessary level. (See sketch drawing) At its highest elevation, a single metal tube was connected to convoy hot Freon vapors away, (which was a product of its own internal energy) directly into a network of copper cooling veins. That were located within all the available space on the outside surrounding of the walls and accompanying this was a single narrower metal tube, which was design to act as a one-way re-entrance vessel for subsequent cooler Freon to enter into compartment IV at the lowest point on its base within a gravitational flow plane (not represented by sketch drawing). Again Boyles's Law was applied using temperature as a convenient constant.

The preceding mentioned copper cooling fins were in turn attached to a copper mesh of an applicable geometric pattern, on their surrounding surfaces, establishing a relation of one of the most points of contacts that were possible. This mesh was then in tern being fused to a copper strip which was made to also enter directly into receptacle 10 at the lowest point on its base so as to facilitate a heat exchange interaction between the “Feed” it contains (Not represented by sketch drawing). The copper cooling veins, the copper mesh and a segment of the copper strip were then encapsulated within the confines of an air—tight super thermo insulated plastic covering, which was then being vacuumed. The exposed segment of the copper strip was also thermo insulated (Not represented by sketch drawing). This unique design layout was used to facilitate the rapid conduction of heat away from the cooling veins, directly depositing it into receptacle 10 and simultaneously inhibits heat loss due to radiation The force of gravity, that of the convector current, the pressure differentials which was operating within compartment IV and the copper cooling veins networks, there encapsulation and inter connection with receptacle 10, had cause this systematic arrangement of material to function as a self sustainable refrigerating unit independent of any mechanical assistance. The pressure law had being applied again, by using several smaller vessels of lesser volume with the intent to increase pressure, so as to efficiently convey cooler “Feed” and it vapors away from chambers III (this feature is not clearly being represented by 16 on sketch drawing) as it was functioning along a gravitational flow plane, a self perpetuating “Feed” circulation system was eventually attainable as the operating systems within gathers momentum and starts to function in there intended coherent manner. This implementation had greatly enhanced the energy conservation initiative, thus improving the overall operational efficiency of the “Molecular Energy Extraction Chambers”. The created temperature deferential that had excised within the chambers had enhanced the collective “Feed” recycling initiative, which was a key preventive player in the formation of a backward pressure within the confines of the chambers, that which would have inhibits the efficient operation of the “Molecular Energy Extraction Chambers”.

All equipment and auxiliaries within the apparatus were super thermo insulated (Vacuumed insulated to minimize heath lost as greatly as possible/greatly enhances heath transfer due to conduction) as the design criteria had dictated. All supplies of energy for the operation of equipment were supplied directly by the “Battery Bank.” The preceding mentioned cooler “Feed” and it vapors were vacuumed sucked and pumped to receptacle 10 from chamber's III via the smaller mentioned vessels, that which were equipped with arrays of valves to prevent back flow of hotter “Feed” due to extreme pressure build in receptacle 10 (see sketch drawing for limited view). The “Feed” and it vapors were restored of its the Latent energy they had initially contained to a very great degree, all due to the super thermo insulation that 10 was enclosed within and its facilitation of the mixing interaction with the heat it was receiving. Receptacle 10 was positioned to also receive “Feed” from a larger holding vessel 20 using gradational flow (see sketch drawing). The Substances from within 10 were allowed to interact with the Fluid Injection pump 11, via a line connection 22 (see sketch drawing). Receptacle 10 had served the purpose of being a devise that what was providing, the service of minimizing Latent Energy lost from itself due to conduction and eventually radiation, being the collecting hub within the “Feed” recycling and energy conservation mechanisms, that there had no time be within the confines of its walls the presence of air (as combustion and possible explosive agent) and there was always a adequate volume of “Feed” to be supplied to chamber's I. One of the paramount features which had made the accomplishment of these qualities possible was the placement of an automatic devise 9 between the line connecting 20 and 10. (See sketch drawing) The in-depth concepts in the design of 9 are subsequently available in this document below. The devise 20 had acted as the chief receptacle for the containment of the largest volume of “Feed” within the “Molecular Energy Extraction Chambers” and simultaneously as the safety devise that what was destine, to ensure the safe operation of the said. This was accomplished by the unique safety devises incorporated within 20 and there special conjoining apparatus. (This is not represented by sketch drawings).

The sequences of processes that had occurred during the operation of the “Molecular Energy Extraction Chambers” coincides with the second law of thermodynamics (If a process occurs in a closed system, the entropy of the system increases for irreversible processes and remains constant for reversible process. It never decreases.) It is correct to conclude that the “Molecular Energy Extraction Chambers” had operated on the premise, that which was an unorthodox approach to the very sequence of events that are embodied within the General Theory of Relativity by basically compressing space and time, intentionally extracting large volumes of energy from matter and in doing so consume negligible mass in the process. It is correct to analyze the General Theory of Relativity as one which is establishing that the quantity Mass is a direct product of tremendously vast amount of energy traveling through space over aeons of time and as a result of constriction to critical points, form Matter (mass). In term this formed entity posses the ability to further contain energy in and within itself to a point called its “Thresh hold Volume”. It is because of this complexity that Mass at the contemporary level is being referred to as a separate quantity from energy. This apparatus was able to produce a vast amount of electrical energy collectively in stark contrast to the volume of electrical energy it was receiving at ant time period and with little lost in volume of its chemical energy source over a long period of time.

The over all efficiency of “Molecular Energy Extraction Chambers” can climb up to 80-85% and even greater, dependent on how effectively it is being custom design and integrated into the required system/s. Material science will play a pivotal role in the commercialization of this revolutionary technology. And the integration of a net work of sensors/indicators of various varieties and computerization of its operating systems will greatly enhance the efficient operation and safety of this technology.

### DETAILED DESCRIPTION 9

I am now proceeding to present a detailed summary of the mechanical process and there operative ness, derived during modeling that embodies 9. The device has operated on the premises that a circular rubber seal with a hallowed core that contain a hardened cylindrical sleeve around its core was held air tight within the confines of a reinforced plastic tube. Within the sleeve of the rubber seal a smooth moving plastic piston was placed.

The piston was design with longitudinal impressed serration around its circumference (Mimicking the pattern on a conventional automobile serpentine belt), which were made to accommodate the downward flow of “Feed”. On its base was a larger rectangular plastic float of adequate size, attached by a screwing mechanism. The plastic float constituted of a thick and soft rubber seal being held in place, beyond it circumference at the point where it attaches it self to the piston, serving as a sealing mechanism when it becomes buoy in the “Feed”, preventing “feed”/vapors and heat from escaping to the other side into receptacle 20. The float was been held with the confines of a much larger receptacle, than what the preceding mentioned rubber seal was held within. This was used to reasonably reduce the amount of pressure it was exposed to due to the heating activities within 10, but yet serve its design function of allowing “Feed” from receptacle. 20 to pass through effectively when the situation warrants (Boyle's Law again applies, using temperature as a convenient constant). The top surface area of the piston was attached to a plastic rod in a perpendicular manner. This had server the purpose of preventing the piston from passing through the rubber sleeve and yet was allowing “Feed” from 20 to pass through to 10 automatically when there was a drop in supply level this apparatus was constructed of primarily plastic, because of its super thermo insulating quality.

The “molecular Energy Chambers” when incorporated into modified designs of contemporary land transportation vehicles, exempting there conventional petrol engine, will results in the production of remarkable alternative energy vehicles. It can appropriately be implemented to stand as an individual unit or in small modules, consisted of the three main chambers and there axillaries components, collectively sharing the use of a single “Battery Bank”, the electrical pumps, the two “Feed” receptacles and the net work of sensors and computerized operating systems. Integrating in concert with the essential technologies of Hydrodynamics, Aerodynamics (Wind tunnel designing) Re-generative breaking (Dynamic Breaking) “Generative Breaking” (the affixing of Magnetos in the hubs of vehicles) photovoltaic systems (Usage of Solar Modules/the painting of the vehicle's body using paint consisting of Nano photovoltaic Units within) Wind generating Alternators (The strategic affixing of Turbine blades design alternator/s with projectile shaped nose at their center, into the vehicle's body with the intent to generate electricity from the movement of the vehicle) in proportions as the individual situation warrants. Magnetic coupling between drive and driven can be used to develop adequate amount of Rotational Kinetic Energy, to be used as a large and direct initial torque force to displace the vehicle at any time to mainly over come the problem of “sticking” that almost all conventional production line electric vehicles faces. The “Molecular Energy Extraction Chambers” can be incorporated in to modified designs of conventional transport jets etc. By being the source that which will produce electricity to be utilized in their propulsion system/s. This can be attainable by replacing the burners in the conventional Jet Turbine Engine with devices that uses capacitance to produce high intensity electrical flames; these units can be made to fire in such a sequence as to maintain a constant volley of their flames. The end result will be adequate clean thrust for propulsion. In conjunction with aerodynamics the forward section of the fuselage can also be made into a rotational capable cylindrical magneto which is equipped with an arrangement of helical blades on its external circumference, that uses the movement of the air craft to deduce torque for the generation of supplementary electricity and the external surrounding of the craft can be covered with paint that contains Nano photovoltaic units, that will be used for the generation of supplementary electricity, thus creating an aviation revolution. This system can also be applied to marine vessels of varying sizes, to be used as the main source of producing electricity for their propulsion system/s. In conjunction with hydrodynamics and conventional marine designing the submerged bow of the vessel can be made into a rotating capable cylinder on which is mounted an arrangement of helical blades. That uses the directional thrust of the vessel as it travels through the water to generate torque which in turn can be used to generate supplementary electricity. Similar designs of units can also be strategically incorporated to the submerged sides of the vessel and the very same end result can be obtained when harnessed and Nano photovoltaic units within the covering paint can also be applied, with the same preceding mentioned objective.

### The “Quantum Mechanical Phenomena” (Solids)

It is basically the natural occurrences that dictate the absorption of energy from the environment by solid moving matter. This invisible sub-atomic occurrence is natural and can be equated by using contemporary knowledge in Material Science and physics. This is a constant interaction of sub-atomic particles between and within moving matter and the environment that coincides with the present atomic theory on the structure and quantum particulate behavior within the individual atoms it self. To successfully capture, effectively harness and use kinetic energy from the environment to enrich an already moving object (“Energy of Inertia”) it is very essential to understand and equate the quantum mechanical behavior of solid moving matter as a whole entity that is interacting with its environment, which is dictated by the subsequent theory of the “Quantum Mechanical Phenomena”.

I now summarize the general theory of the “Quantum Mechanical Phenomena” it states that the amount of kinetic energy that can be capture from the environment by a moving object (Solids) at any given speed, for any period of time period, when a force is applied to it is directly, depends on the shape (aerodynamics/hydrodynamics) mass, atomic structure, surface area volume ratio of the material and the surrounding environmental pressure during motion, the derived general kinetic energy value is intern, prop ional to the material total energy state (volume) during the course of motion. This which is further simplified for the purpose of clarity and equating by relating that “Energy of Inertia” is directly proportional to the force applied (includes the direct introduction of electricity into the object) for a moving object and as soon as the driven object becomes, disassociated from it source/s of force its kinetic energy contents starts immediately to deplete in minute increments proportional to its current total energy volume at it's time of disassociation from the driven force and hence forth the continuance of the same processes for each finite change in time, where each time interval creates a new energy volume for the moving object, Until the object comes to rest due to a constant, gravitational interference and in terms of space small gravitational forces/cosmic forces (Quantum abrasive forces, solar winds etc) In the circumstances when the applied force is that of gravity to the object, in conjunction with the other governing factors within the general theory of the “Quantum Mechanical Phenomena” it will results in the object developing momentum to the extent its “Energy of Inertia” causes it to start consuming it self and even implodes if traveling distance is a factor of sufficiency. Within the “Quantum Mechanical Phenomena” Aerodynamics/Hydrodynamics play a very significant role where the extent of stream lining is directly proportional to “Energy of Inertia” when natural forces is a constant factor, that is to establish that there is a natural energy balancing process occurring within the atoms in moving object, where the volume of drag surface area and streamlined surface area that are simultaneously exposed to the environment, dictates if the moving object will gain or lost energy to the environment as a final out come. This energy balancing process is caused due to the interchanging and frequent random collation of electrons from the environment and that of those within the moving object, where by electrons constantly changes there energy states within and among atoms, as they makes quantum jumps within there respective atoms and other near by atoms, where high energy value electrons from the environment pushes its way in to the atoms of the moving object and occupy and in so doing expelling electrons of lesser energy out of its respective atom and sustains a chain event for streamlined surface area and vice versa for drag surfaces, finally dictating weather energy will be gained or lost to the environment as a net outcome. When a moving object becomes saturated with high energy value electrons its temperature starts to rise rapidly which can leads progressive to self consumption and eventually to implosion. The natural self assessing atomic process for energy is believed to be occurring at speeds faster than that of light and is governed by the laws of probabilistically mathematics. It is correct to encapsulate that the “Quantum Mechanical Phenomena”, occurs on the premise that net quantum motions equals to precise Mathematical predictability even when the theory of uncertainty is factored in because Knowledge in material science will provide the significant figures, that which will dictate the final result. Rotational kinetic energy is the occurrence of “Energy of Inertia” in rotating objects with a gyration, where by mechanical energy can be directly converted into torque.

It is correct to summarize that the “Molecular Energy Extraction Chambers” is an apparatus with a simple solution for a very complex problems.

I. I Sridat Chinsammy is claiming sole propriety rights on the idea and invention of the “Molecular Energy Extraction Chambers” and is totally interlocking the patentable contents of the Abstract, Description and Drawing of my Non-provisional patent application dated Jun. 11, 2007, in the widest prospective conceivable, because I am the first person to conceive and protect such a unique idea and invention.

II. Alternately I am interlocking the substance within claim's number one # (I) as a whole, with the possibility of providing ideal temperature and the chemical “Feed” to purposely facilitate combustion to occur within chambers I, II and III of the Molecular Energy Extraction Chambers, as the next optional methodology, of extracting and converting energy into electricity.
